(19) United States
(12) Patent Application Publication
(10) Pub. No.: US 2012/0053940 A1
(43) Pub. Date: Mar. 1, 2012

(54) SYSTEM AND OPERATION METHOD FOR PROCESSING DOOR-TO-DOOR PARCEL ACCEPTANCE INFORMATION BASED ON VOICE RECOGNITION

(75) Inventor: Hea Won LEE, Daejeon (KR)

(73) Assignee: Electronics and Telecommunications Research Institute, Daejeon (KR)

(21) Appl. No.: 13/217,373

(22) Filed: Aug. 25, 2011

(30) Foreign Application Priority Data
Aug. 25, 2010 (KR) 10-2010-0082626

(51) Int. Cl. G10L 17/00

(52) U.S. Cl. 704/246; 704/E15.001

(57) ABSTRACT

Disclosed are a system for processing a door-to-door parcel acceptance and a method thereof. The post office server includes: a voice input block that receives acceptance application and collecting location information for the postal matter by voice and creates corresponding voice data; a door-to-door parcel information process block that acquires the acceptance application information and the acceptance information implemented by characters, by performing voice recognition to the voice data and provides information for each process of a door-to-door parcel acceptance work in real time by processing the acceptance application information and the acceptance information; and a acceptance management block that displays and stores the information output from the door-to-door parcel information process block.

### CROSS-REFERENCE TO RELATED APPLICATIONS

This application claims priority under 35 U.S.C. §119 to Korean Patent Application No. 10-2010-0082626, filed on Aug. 25, 2010, in the Korean Intellectual Property Office, the disclosure of which is incorporated herein by reference in its entirety.

### TECHNICAL FIELD

The present invention relates to a system for processing door-to-door parcel acceptance information and a method thereof, and more particularly, to a system for processing door-to-door parcel acceptance information for efficiently performing door-to-door parcel accepting works, on the basis of information accompanying in the process of the door-to-door parcel acceptance from door-to-door parcel application to a finishing process after gathering of goods, and a method thereof.

### BACKGROUND

Mail services are largely divided into a common mail service and a parcel mail service. Each service is divided into a registered mail service that is specially handled and processed from the acceptance and the delivery, and records and manages the delivery process, and a standard mail service that delivers postal matters without recording and managing. The common mail service usually handles common envelopes and portfolios with postal matters and the parcel mail service is a service that has a difficulty in handling objects above a predetermined size and is used to mail objects under 30 kg. The parcel mail service falls into a standard parcel service and a registered parcel service when being accepted at the windows in a post office, but door-to-door mail service is accepted as the registered mail service that provides the whole record and management service. The reason is that the postal matters may be lost or damaged, because they are sent and delivered from customer desired places outside the post office.

Application of the door-to-door parcel mail service is made by telephone application (on the telephone numbers of local post offices or the telephone numbers of the call centers of post offices), internet application, and direction application at post offices. Most of door-to-door parcel applications are made by telephone, in which when application is made by a wire phone call on the call center, a receptionist in the application area is directly connected, but when the application is made by a mobile phone, the call center accept the application and sends it to a receptionist in the post office in the corresponding area.

The receptionist provides the application information of the corresponding district to the collector in charge of collection for the districts of jurisdiction in the area The collectors puts together the door-to-door parcel application information of the sections under their charge and check the scheduled arrival time and the detailed collecting locations while moving to the collecting locations.

An accident may occur when the receptionist calls the door-to-door parcel applicants to check the collecting locations while traveling the vehicle, whereas calling the door-to-door parcel applicants, with the vehicle pulled over, takes too much time and may cause traffic congestion.

Further, when door-to-door parcel is received by telephone, the information is too much for the receptionist to receive all the acceptance information from a customer, such that it causes the customer inconvenience and the usability is reduced due to many misrecognized characters. Therefore, only the sender's name, address, and phone number from the application information are used as information for going to the collecting location.

As described above, since the door-to-door parcel application acceptance work depends on writing on paper with a hand, it is inconvenient and the cost is generated by the use of marking papers.

Further, since the acceptance information is not input in a database upon being received, the receptionist should return to the post office and input the information one by one with a computer keyboard, cannot collate the number of parcels received in that day with the results, and cannot settle the account after collating the collected delivery charges with the actual parcels, but settles the account when the information is input after receiving the delivery charges from the collectors, such that there are many problems when a parcel is lost.

### SUMMARY

An exemplary embodiment of the present invention provides a post office server for processing door-to-door parcel acceptance information based on voice recognition, the server including: a voice input block that receives acceptance application and collecting location information for the postal matter by voice and creates corresponding voice data; a door-to-door parcel information process block that acquires the acceptance application information and the acceptance information implemented by characters, by performing voice recognition to the voice data and provides information for each process of a door-to-door parcel acceptance work in real time by processing the acceptance application information and the acceptance information; and an acceptance management block that displays and stores the information output from the door-to-door parcel information process block.

Another exemplary embodiment of the present invention provides a method for operating a system for processing door-to-door parcel acceptance information based on voice recognition that is performed by a post office server, the method including: receiving acceptance application of a postal matter by voice and acquiring acceptance application information including at least one of a name, an address, and a telephone number by performing voice recognition; assigning a post office and a collector in charge of a corresponding area in accordance with the acceptance application information; receiving collecting location information from a collecting location by voice and acquiring acceptance information including at least one of receiver information, sender information, parcel information, and settlement information by performing voice recognition; transmitting a signal for outputting a receipt and an invoice for the corresponding item to the terminal, in accordance with the settlement information; storing final acceptance information composed of characteristic information transmitted from the terminal; and outputting finishing information including a settlement fee and a registered number of an individual parcel from each collector, from the final acceptance information.

Other features and aspects will be apparent from the following detailed description, the drawings, and the claims.

### BRIEF DESCRIPTION OF THE DRAWINGS

FIG. 1 is a block diagram showing a system for processing door-to-door parcel acceptance information based on voice recognition according to an exemplary embodiment of the present invention.

FIG. 2 is a configuration view showing a door-to-door parcel acceptance information process block shown in FIG. 1, according to an exemplary embodiment of the present invention.

FIG. 3 is a configuration view showing a door-to-door parcel application information acquiring unit shown in FIG. 2, according to an exemplary embodiment of the present invention.

FIG. 4 is a configuration view showing a door-to-door parcel collector assigning/confirming unit shown in FIG. 2, according to an exemplary embodiment of the present invention.

FIG. 5 is a configuration view showing a home collecting location acceptance information acquiring unit shown in FIG. 2, according to an exemplary embodiment of the present invention.

FIG. 6 is a configuration view showing a door-to-door parcel acceptance registration/receipt/invoice issue unit shown in FIG. 2, according to an exemplary embodiment of the present invention.

FIG. 7 is a configuration view showing a door-to-door parcel finishing information process unit shown in FIG. 2, according to an exemplary embodiment of the present invention.

FIG. 8 is a flowchart showing a process of processing a parcel acceptance by recognizing voice, using a voice POC database in a method processing door-to-door parcel acceptance information based on voice recognition according to another exemplary embodiment of the present invention.

FIG. 9 is a flowchart showing a process of acquiring door-to-door parcel application information by recognizing voice, using a voice POC database in a method for processing door-to-door parcel acceptance information based on voice recognition according to another exemplary embodiment of the present invention.

FIG. 10 is a flowchart showing a collector assigning/confirming process that provides information to a person in charge of a corresponding district in a corresponding area on the basis of the door-to-door parcel acceptance information based on voice recognition information recognized from voice in a method for processing door-to-door parcel acceptance information based on voice recognition according to another exemplary embodiment of the present invention.

FIG. 11 is a flowchart showing a process of acquiring site acceptance information on the basis of voice-recognized door-to-door parcel information in a method for processing door-to-door parcel acceptance information based on voice recognition according to another exemplary embodiment of the present invention.

FIG. 12 is a flowchart showing a process of issuing a receipt and an invoice and registering information on the basis of parcel acceptance information in a method for processing door-to-door parcel acceptance information based on voice recognition according to another exemplary embodiment of the present invention.

FIG. 13 is a flowchart showing a process of taking over a parcel to an official in a post office and outputting final finishing information on the basis of acceptance information in a method for processing door-to-door parcel acceptance information based on voice recognition according to another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, exemplary embodiments of the present invention will be described in detail with reference to the accompanying drawings.

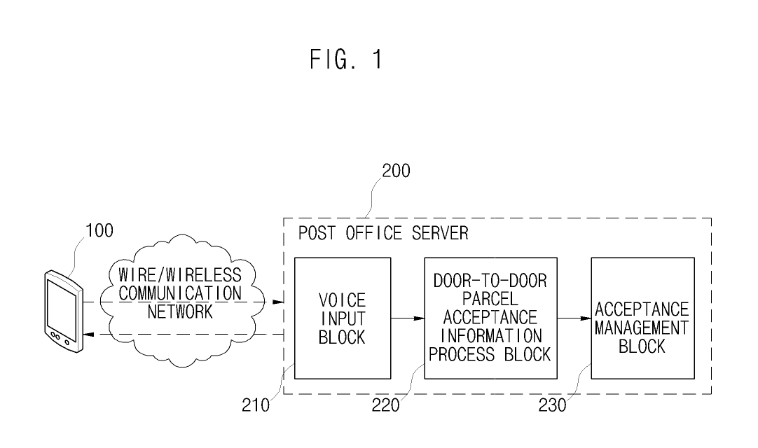

A system for processing door-to-door parcel acceptance information based on voice recognition according to an exemplary embodiment of the present invention is described with reference to FIG. 1. FIG. 1 is a block diagram showing a system for processing door-to-door parcel acceptance information based on voice recognition according to an exemplary embodiment of the present invention.

Referring to FIG. 1, a system for processing door-to-door parcel acceptance information based on voice recognition according to the exemplary embodiment of the present invention includes a terminal 100 and a post office server 200. In this configuration, the terminal 100 implies a device that a customer uses to apply for a door-to-door parcel by telephone and a common telephone, a PDA, a mobile phone, an iPhone, a Wipon, and a smart phone etc., which are linked in wire/wireless communication with the post office server 200 in order for a collector to process works for delivering parcels.

The post office server 200 may include a voice input block 210, a door-to-door parcel information process block 220, and an acceptance management block 230, etc.

The voice input block 210, for example, processes door-to-door parcel application information and door-to-door parcel acceptance information which are input through a telephone receiver or a microphone of the terminal 100 by voice to receive a postal matter.

In detail, the voice input block 210 receives information, such as a name, an address, and a telephone number, for application acceptance of a door-to-door parcel, by voice, receives sender information, receiver information, postal matter information, and settlement information etc., which are necessary for receiving a door-to-door parcel collection, and transmits the voice data to the door-to-door parcel acceptance information process block 220.

The door-to-door parcel acceptance information process block 220 recognizes a variety of acceptance application information (e.g. information on the applicant's name, the collection address, and the telephone number) for determining a post office in charge of collection or a collector by voice, using a voice POI database, and recognizes a variety of acceptance information (e.g. the receiver information, the sender information, the postal matter (article) information, and settlement information) for receiving the door-to-door parcel matter, by voice, thereby acquiring information.

For example, the door-to-door parcel acceptance information process block 220 can increase voice recognition performance by searching the voice data of the application information and the acceptance information from the voice recognition database of the corresponding area to limit the area range for voice recognition to the corresponding application area.

For this purpose, the door-to-door parcel acceptance information process block 220 acquires information on a name, an address (up to Dong), and a telephone number. If door-to-door parcel application is made by telephone from an area outside the collecting area or door-to-door parcel application is made by a mobile phone, the door-to-door parcel acceptance information process block 220 reduces the voice recognition range by inputting codes dividing the whole country into local districts and takes the whole country as a voice recognition range when the local code of the customer is not input, thereby acquiring information.

Further, the door-to-door parcel acceptance information process block 220 determines a postal office in charge of the door-to-door parcel collecting area and a collector in charge, using the recognized acceptance application information, and transmits the door-to-door parcel application information to the terminal 100 of the collector.

Further, door-to-door parcel acceptance information process block 220 receives voice, which is input through the terminal 100 of the collector at a collecting location, through a wireless communication network, and acquire acceptance information by recognizing the voice.

Further, door-to-door parcel acceptance information process block 220 transmits a signal for printing only one receipt and one marking paper (invoice) to attach to a parcel for each parcel, to the terminal 100 of the collector on the basis of the acquired acceptance information. Although when ten parcels are received, ten receipts, ten invoices to attach to the parcels, and ten invoices for post office, that is, total thirty sheets are issued by using triple invoices in the related art, according to the exemplary embodiment of the present invention, it has only to issue one receipt and ten sheets of parcel labels, that is, total eleven sheets, such that the cost for the invoices is considerably reduced.

As described above, the door-to-door parcel acceptance information process block 220 recognizes the acceptance application information and the sender information, receiver information, postal matter information, and settlement information which are acquired to receive the parcel, and outputs the recognized postal matter acceptance information to the acceptance management block 230.

Meanwhile, the acceptance management block 230 displays the door-to-door parcel matter acceptance process information output from the door-to-door parcel acceptance information process block 220 and then stores the corresponding postal matter acceptance information in accordance with confirmation input from the postal matter receiver, such that the postal matter acceptance process is completed.

Although it has been described in the above exemplary embodiment of the present invention that the door-to-door parcel acceptance information process block 220 separately acquires the acceptance application information and the door-to-door parcel acceptance information, the address and the zip code can be stored in a database as interrelated information, such that it is obviously possible to simultaneously acquire the address information and the zip code information by making an address information database and a zip code information database in one database and searching characters of the address with the numbers of the zip code.

Further, the voice POI data base may be configured by selecting, as needed, various databases that are used for postal office acceptance, for example, including a name feature vector database, an address feature vector database, and a telephone number feature vector database, which are in connection with the application information, and an address feature vector database, a zip code information database, which are in connection with the acceptance information, and a zip code information feature vector database, a zip code information database, customer information database, a postal matter information feature vector database, a postal matter information database, and settlement information database, which are in connection with each district.

Therefore, the system for processing door-to-door parcel acceptance information based on voice recognition according to the exemplary embodiment of the present invention can easily acquire postal matter acceptance information by constructing various voice feature vector database and various information database for acquiring the name, address, and telephone number, which are the door-to-door parcel application information, and the address information, zip code information, telephone number information, postal matter information, and settlement information, which are the acceptance information.

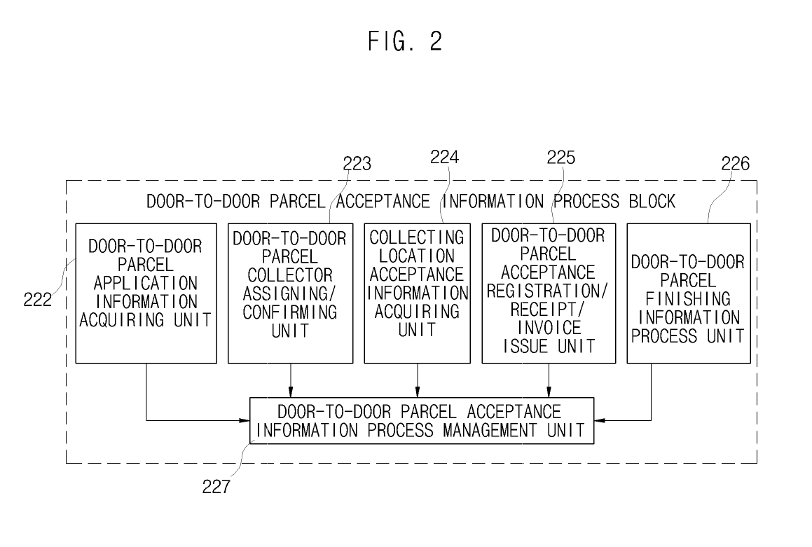

The door-to-door parcel acceptance information process block according to the exemplary embodiment of the present invention is described with reference to FIG. 2. FIG. 2 is a configuration view showing a door-to-door parcel acceptance information process block shown in FIG. 1, according to an exemplary embodiment of the present invention.

Referring to FIG. 2, the door-to-door parcel acceptance information process block 220 according to the exemplary embodiment of the present invention includes a door-to-door parcel application information acquiring unit 222, a door-to-door parcel collector assigning/confirming unit 223, a collecting location acceptance information acquiring unit 224, a door-to-door parcel acceptance registration/receipt/invoice issue unit 225, a door-to-door parcel finishing information process unit 226, and a door-to-door parcel acceptance information process management unit 227.

When voice input data about the applicant's name, address, and telephone number for home deliver acceptance application is transmitted from a voice input block, the door-to-door parcel application information acquiring unit 222 extracts voice feature vector from the corresponding voice data, performs pattern-matching with the voice feature vector database, and then extracts name, address, and telephone number words having the same patterns as the voice feature vector from the voice feature vector database.

Further, door-to-door parcel application information acquiring unit 222 searches the address words in the extracted words from the address information database and acquires the searched corresponding address information.

For example, the door-to-door parcel application information acquiring unit 222 extracts an address voice feature vector from the input address voice input data, separate the voice feature vector in accordance with an address vocalization way, and can acquire the address information including a Dong-name feature vector or a Gu(Myeon)+Dong(Ri)-name feature vector, using the separated address voice feature vector.

Further, the door-to-door parcel application information acquiring unit 222 extracts a telephone number voice feature vector from the input telephone number voice input data, matches feature vector patterns, using the telephone number vector database, extracts the telephone number words (numbers), searches the extracted telephone number words from a customer information database, and then searches additional information from the customer information database when the corresponding telephone number has been searched, thereby acquiring mixed door-to-door parcel application information.

For example, the door-to-door parcel application information acquiring unit 222 separates a telephone number feature vector in three words, matches the pattern of the extracted telephone number feature vector with those in the telephone number feature vector database including an area/mobile phone feature vector, a telephone exchange number feature vector, and a telephone number feature vector, in accordance with the corresponding words, extracts telephone number words, such as the area/mobile phone, telephone exchange number, and telephone number, and searches the telephone number words from the customer information database including customer telephone numbers etc., thereby being able to acquire telephone number information corresponding to the door-to-door parcel application information.

When the door-to-door parcel acceptance application information is transmitted from the door-to-door parcel application information acquiring unit 222, the door-to-door parcel collector assigning/confirming unit 223 extracts the zip code from the address information, searches the post office in charged and the collector in charge from a database of the in-charge post office/collecting office on the basis of the extracted zip code, and then transmits the acceptance application information to the corresponding collector.

The collecting location acceptance information acquiring unit 224 extracts acceptance information voice feature vectors from the acceptance information voice data transmitted from a collecting location (e.g. the receiver information (name, address, zip code, telephone number, and mobile phone number), the sender information (name, address, zip code, telephone number, and mobile phone number), the parcel information (parcel content, weight, size, fee, specific handling and transporting instructions etc.), and the settlement information (immediately paid, separately paid, subsequently paid, non-paid, card)), performs pattern-matching between the extracted voice feature vector and the acceptance information feature vector database, thereby acquiring character acceptance information.

The door-to-door parcel acceptance registration/receipt/invoice issue unit 225 receives the acceptance information from the collecting location acceptance information acquiring unit 224, gives an acceptance number and a registered number to the corresponding received item, and transmits a signal for printing a receipt and an invoice to the terminal of the collector, using a wireless communication network.

The door-to-door parcel finishing information process unit 226 collects the acceptance information of postal matters that have been received at the collecting location and outputs finishing information. The finishing information includes the results of comparing the paid fees and the registered numbers of the door-to-door parcel parcels for each collector, based on the collected acceptance information.

Meanwhile, collectors return to the post office and give the collected delivery charges to a counter in the post office after finishing the door-to-door parcel collection, such that the counter can easily receive the delivery charges from the collectors, using the output finishing information and the collectors also can easily confirm the delivery charges that they have given, using the finishing information output on the terminals.

Further, the collector and the arrival-departure official can efficiently take over by confirming the results automatically comparing the registered numbers, without comparing the registered numbers of the collected parcels.

The door-to-door parcel acceptance information process management unit 227 acquires postal matter process information, such as the door-to-door parcel application information, the acceptance information, the acceptance number, the registered number, for acceptance process of the postal office from the door-to-door parcel application information acquiring unit 222, the door-to-door parcel collector assigning/confirming unit 223, the collecting location acceptance information acquiring unit 224, the door-to-door parcel acceptance registration/receipt/invoice issue unit 225, and the door-to-door parcel finishing information process unit 226, and transmits the acquired postal matter process information to an acceptance management block 230.

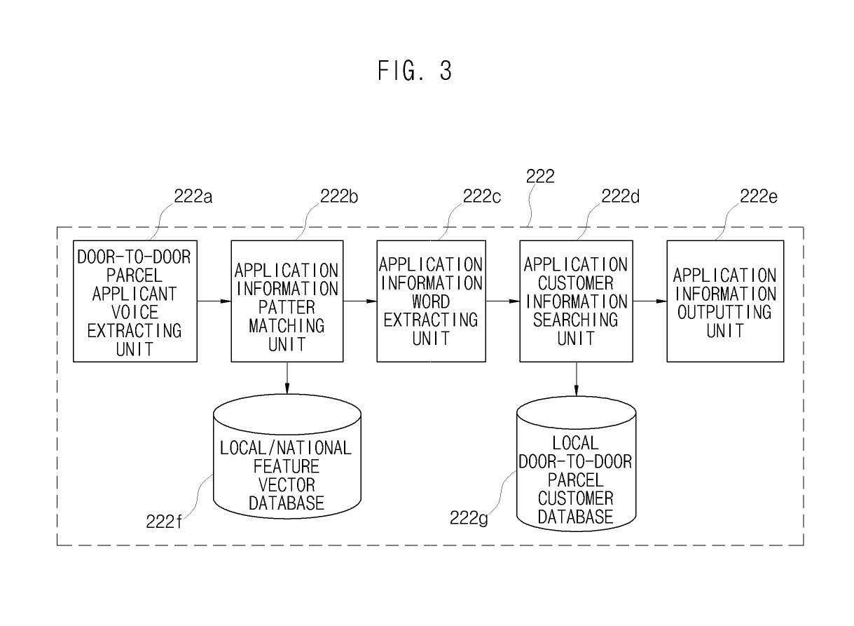

The configuration of the door-to-door parcel application information acquiring unit for acquiring the door-to-door parcel application information from the voice data, according to an exemplary embodiment of the present invention, is described with reference to FIG. 3. FIG. 3 is a configuration view showing a preferred embodiment of the door-to-door parcel application information acquiring unit shown in FIG. 2, according to an exemplary embodiment of the present invention.

Referring to FIG. 3, the door-to-door parcel application information acquiring unit 222 may include a door-to-door parcel applicant voice extracting unit 222a, an application information pattern matching unit 222b, an application information word extracting unit 222c, an application customer information searching unit 222d, an application information outputting unit 222e, a local/national feature vector database 202f, and local door-to-door parcel customer database 222g.

The door-to-door parcel applicant voice extracting unit 222a extracts a door-to-door parcel application voice feature vector from the door-to-door parcel application voice data for the door-to-door parcel applicant which is transmitted from the voice input block.

The application information pattern matching unit 222b separates the extracted door-to-door parcel application voice feature vector into a name, an address, and a telephone number and acquires the name, address, and telephone number by matching the patterns of the separated name, address, and telephone number with the local/national feature vector database 222f composed of name, address, and telephone number voice feature vector databases.

The application information word extracting unit 222c extracts the application information words acquired by the application information patter matching unit 222b and separates and transmits the name, address, and telephone number to the application customer information searching unit 222d.

The application customer information searching unit 222d searches the local door-to-door parcel customer database 222g on the basis of the address, telephone number, and name which are transmitted from the application information word extracting unit 222c to ascertain whether the customer has been registered, and registers the customer and transmits the search result to the application information outputting unit 222e, when there is no matched customer.

The application information outputting unit 222e outputs the searched or acquired application information to the door-to-door parcel acceptance information process management unit.

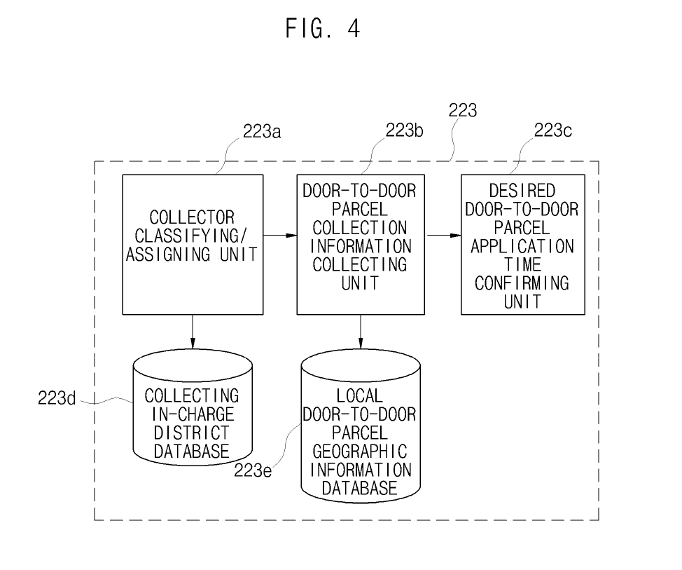

The configuration of the collector assigning/confirming unit for assigning a collector in charge of an area on the basis of the application information, according to an exemplary embodiment of the present invention, is described with reference to FIG. 4. FIG. 4 is a configuration view showing a preferred embodiment of the door-to-door parcel collector assigning/checking unit shown in FIG. 2, according to an exemplary embodiment of the present invention.

Referring to FIG. 4, the door-to-door parcel collector assigning/confirming unit 223 may include a collector classifying/assigning unit 223a, a door-to-door parcel collection information collecting unit 223b, a desired door-to-door parcel time confirming unit 223c, a collection in-charge district database 223d, and a local door-to-door parcel geographic information database 223e.

The collector classifying/assigning unit 223a searches the collection in-charge district database 223d, using the address information in the application information transmitted from the door-to-door parcel application information acquiring unit, classifies/assigns mapped in-charged post office and collector from the searched result, and transmits application information for each application data to the terminal of the corresponding collector.

The door-to-door parcel collection information collecting unit 223b searches the local door-to-door parcel geographic information (GIS) database 223e, using the address information in the application information transmitted from the door-to-door parcel application information acquiring unit, arranges application information on the order of gathering of goods sequence information (geographic information of the applied addresses) mapped by the search, and transmits the arranged application information to the terminal of the corresponding collector.

The desired door-to-door parcel application time confirming unit 223c transmits a message saying the door-to-door parcel application information to the customer when the collector starts to circulate the collection location for collection.

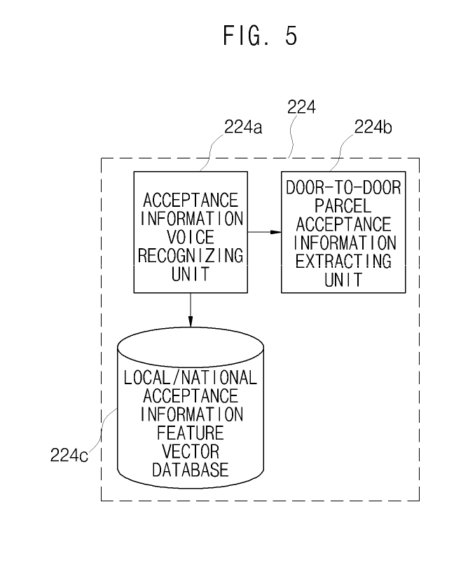

The collecting location acceptance information acquiring unit for extracting acceptance information on the basis of the voice information collected a collecting location, according to an exemplary embodiment of the present invention, is described hereafter with reference to FIG. 5. FIG. 5 is a configuration view showing a preferred embodiment of the collecting location acceptance information acquiring unit shown in FIG. 2, according to an exemplary embodiment of the present invention.

Referring to FIG. 5, the collecting location acceptance information acquiring unit 224 includes an acceptance information voice recognizing unit 224a, door-to-door parcel acceptance information extracting unit 224b, and a local/national feature vector database 224c.

The acceptance information voice recognizing unit 224a recognizes acceptance information by performing feature vector pattern-matching between the local/national feature vector database 224c and the acceptance information, such as the sender information, the receiver information, the parcel information, and the settlement information, which are inputted by voice to the terminal of a collector, and transmits the voice-recognized result to the door-to-door parcel acceptance information extracting unit 224b.

The door-to-door parcel acceptance information extracting unit 224b classifies the transmitted voice-recognized acceptance information for the items of the sender information, the receiver information, the parcel information, and the settlement information, and transmits the classified result to the terminal of the collector. In this case, the acceptance information classified for the items is displayed by characters on the terminal of the collector and transmitted to the door-to-door parcel acceptance information extracting unit 224b after being finally confirmed by a user (e.g. when a user who has confirmed the acceptance information displayed on the terminal presses a confirmation button).

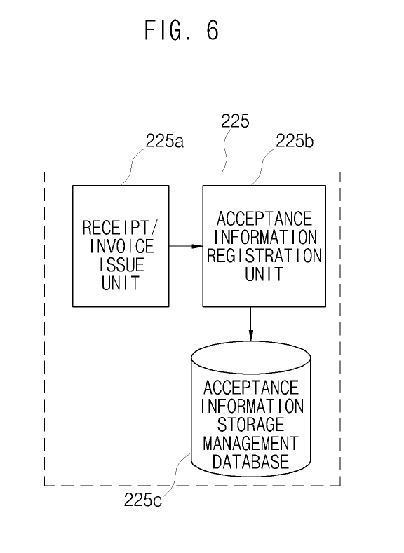

The door-to-door parcel acceptance registration/receipt/invoice issue unit that issues receipts and invoices, using acceptance information, according to an exemplary embodiment of the present invention is described with reference to FIG. 6. FIG. 6 is a configuration view showing a preferred embodiment of the door-to-door parcel acceptance registration/receipt/invoice issue unit shown in FIG. 2, according to an exemplary embodiment of the present invention.

Referring to FIG. 6, the door-to-door parcel acceptance registration/receipt/invoice issue unit 225 includes a receipt/invoice issue unit 225a, an acceptance information registration unit 225b, and an acceptance information storage management database 225c.

The receipt/invoice issue unit 225a transmits a signal for printing a receipt to issue to a customer and an invoice to attach to a parcel to the terminal of a collector, when receiving acceptance information including settlement finishing information from the collecting location acceptance information acquiring unit.

The acceptance information registration unit 225b receives the final acceptance information composed of character information from the terminal of the collector printing the receipt and invoice through a wireless communication network or a cradle that is a computer docking device where the collector mounts the terminal after returning to the post office, and then stores the acceptance information to the acceptance information storage management database 225c.

The final acceptance information is stored in the acceptance information storage management database 225c. That is, sender information, receiver information, parcel information, and settlement information collected through the terminal a collecting location are stored.

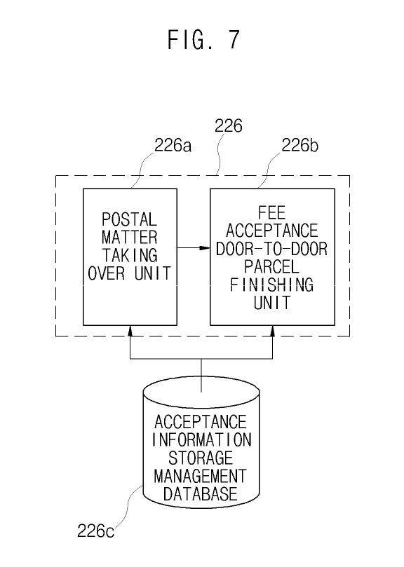

The door-to-door parcel finishing information process unit that outputs the finishing information, using the acceptance information, according to an exemplary embodiment of the present invention is described with reference to FIG. 7. FIG. 7 is a configuration view showing a preferred embodiment of the door-to-door parcel finishing information process unit shown in FIG. 2, according to an exemplary embodiment of the present invention.

The door-to-door parcel finishing information process unit 226 is composed of a door-to-door parcel matter taking over unit 226a and a fee acceptance door-to-door parcel finishing unit 226b.

The door-to-door parcel matter taking over unit 226a extracts individual information including the registered number of the delivered individual parcel from the final acceptance information stored in the acceptance information storage management database, automatically compares the registered number with the registered number of the parcel which has been recognized by a barcode scanner to ascertain whether they are the same, and provides the taking-over result.

The collector and the arrival-departure official can automatically immediately check an error that may be generated in taking-over by seeing the taking-over result displayed on a screen.

The fee acceptance door-to-door parcel finishing unit 226b extracts individual information including the settled fees of the delivered individual parcels, the total settlement fee of the collected parcels, and the registered numbers of the individual parcels from the final acceptance information stored in the acceptance information storage management database.

As described above, the collector, the counter, and the arrival-departure official can conveniently performs the delivery charges acceptance work, using the finishing information provided from the door-to-door parcel finishing information process unit 226, and it is possible to improve the work efficiency by automatically taking over the individual parcels.

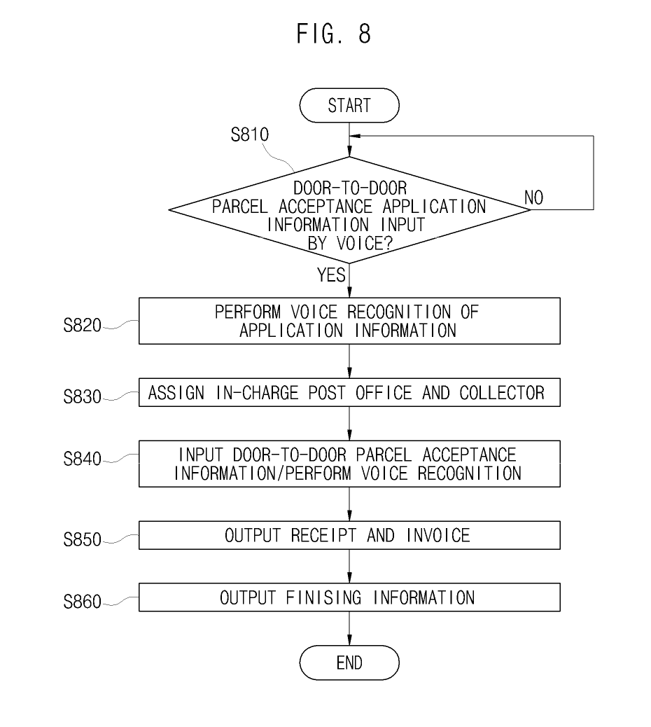

Door-to-door parcel acceptance information based on voice recognition process method according to another exemplary embodiment of the present invention is described with reference to FIG. 8. FIG. 8 is a flowchart showing a process of processing a parcel acceptance by recognizing voice, using a voice POI database.

First, the system for processing the door-to-door parcel acceptance information based on voice recognition determines whether application information for door-to-door parcel acceptance application, for example, a name, an address (Gu/Myeon+Dong/Ri) and a telephone number are input by voice (S810).

When it is determined that voice for door-to-door parcel application has been input, the system for processing the door-to-door parcel acceptance acquires the name, address, and telephone information from the input voice data (S820).

For example, the system for processing the door-to-door parcel acceptance extracts voice feature vectors for the name, address (Gu/Myeon+Dong/Ri), telephone number from the input voice data, matches the patterns with the name, address, and telephone number feature vector databases, and extracts name, address, and telephone number words.

In this process, the system for processing the door-to-door parcel acceptance searches the address words in the extracted application information from the post address information database and can acquire application information by collecting the searched corresponding address, the name, and the telephone number.

Next, the system for processing the door-to-door parcel acceptance assigns a post office and a collector in charge of the corresponding address district, using the address in the acquired application information, and transmits an SMS text message saying that the door-to-door parcel application has been received to the customer, using the telephone number (S830).

Next, when voice data for acquiring receiver information, sender information, parcel information and settlement information, which are the acceptance information, the system for processing the door-to-door parcel acceptance acquires the receiver information, sender information, parcel information and settlement information from the corresponding voice data (S840).

For example, the system for processing the door-to-door parcel acceptance extracts an acceptance information voice feature vector from the corresponding voice data, matches the pattern with the acceptance information feature vector database, and extracts acceptance information words.

In this process, the system for processing the door-to-door parcel acceptance can acquire acceptance information by searching the extracted acceptance information words from the customer information database and acquiring customer information meeting with the extracted acceptance information words.

Next, the system for processing the door-to-door parcel acceptance issues an invoice and a receipt, on the basis of the acquired acceptance information (S850).

For example, the system for processing the door-to-door parcel acceptance may print out a receipt showing the total settlement amount of money for one item or several items of door-to-door parcel, the acceptance numbers, and the registered number, and print out an invoice showing the registered numbers (invoice numbers) of individual parcels, sender information (name, address, telephone number, and zip code), receiver information (name, address, telephone number, and zip code), parcel information (content in the parcel, weight, size, fee, and additional handling and transporting instructions), and settlement information (immediately paid, separately paid, subsequently paid, non-paid, card).

Next, the system for processing the door-to-door parcel acceptance collects the acceptance information of the postal matters received at a collecting location and outputs finishing information (S860). The finishing information includes the fees and the registered numbers of the parcels that have been collected by the collectors, based on the collected acceptance information.

The system for processing the door-to-door parcel acceptance extracts individual information including the registered number of the delivered individual parcel from the final acceptance information, automatically compares the registered number with the registered number of the parcel which has been recognized by a barcode scanner to ascertain whether they are the same, and provides the taking-over result.

The collector and the arrival-departure official can automatically immediately check an error that may be generated in taking-over by confirming the taking-over result displayed on a screen.

Further, the system for processing the door-to-door parcel acceptance extracts and outputs the individual information including the settlement fees of the collected individual parcels, the total settlement fee of collected individual parcels, and the registered numbers of the individual parcels from the final acceptance information.

As described above, the collector, the counter, and the arrival-departure official can conveniently performs the delivery charges acceptance work, using the finishing information provided from the door-to-door parcel finishing information process unit 226, and it is possible to improve the work efficiency by automatically taking over the individual parcels.

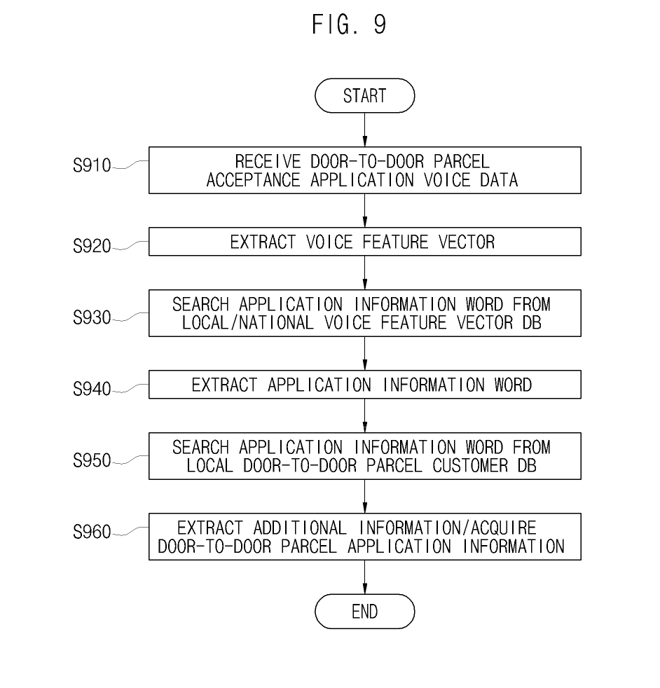

A step of acquiring application information for postal matter acceptance according to another exemplary embodiment of the present invention is described with reference to FIG. 9. FIG. 9 is a flowchart showing a process of acquiring door-to-door parcel application information by recognizing voice, using a voice POC database in a method for door-to-door parcel acceptance information processing based voice recognition according to another exemplary embodiment of the present invention.

First, the system for processing the door-to-door parcel acceptance receives application information voice data for acceptance application of a postal matter (S910) and extracts a voice feature vector from the received application information voice data (S920).

Further, the system for processing the door-to-door parcel acceptance matches the pattern of the extracted voice feature vector with the local/national voice feature vector database (S930) and extracts application information words corresponding to the matched result (S940).

For example, the system for processing the door-to-door parcel acceptance selects the local/national voice feature vector database that is used to pattern matching in accordance with a telephone application area.

If a call for door-to-door parcel application is received from Daejeon, the system for processing the door-to-door parcel acceptance performs pattern-matching for the voice feature vector, using a Daejeon acceptance information feature vector database.

As described above, the system for processing door-to-door parcel acceptance can increase voice recognition performance by reducing the pattern-matching range, by separating the local voice feature vector and then performing pattern-matching.

Next, the system for processing the door-to-door parcel acceptance searches the words extracted in the step S940 from a local door-to-door parcel customer database (S950) and combines additional information of the searched applicant (e.g. zip code, mobile phone/telephone number, detailed address), thereby finally acquiring door-to-door parcel application information (S960).

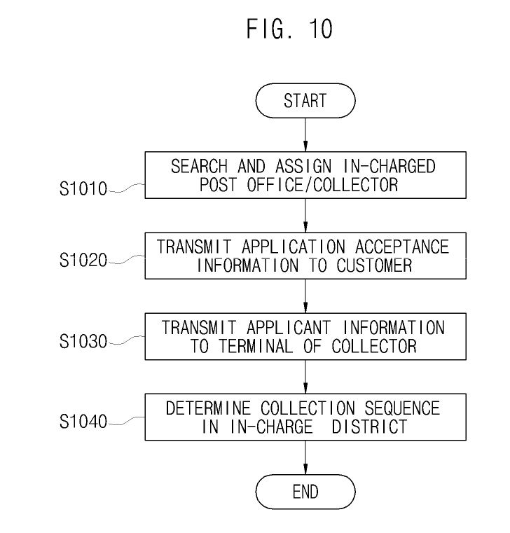

A step of assigning in-charge post office and collector for collecting a postal matter according to another exemplary embodiment of the present invention is described with reference to FIG. 10. FIG. 10 is a flowchart showing a door-to-door parcel collector assigning/checking process that provides information to a person in charge of a corresponding district in a corresponding area on the basis of the door-to-door parcel acceptance information based on voice recognition information recognized from voice in a method for processing door-to-door parcel acceptance information based on voice recognition according to another exemplary embodiment of the present invention

First, the system for processing the door-to-door parcel acceptance searches and assigns a post office and a collector in charged of the application area from the collection in-charge district database on the basis of the address information in the finally acquired door-to-door parcel application information (S1010).

Further, the system for processing the door-to-door parcel acceptance transmits an SMS message saying the collecting data and the collector information to the customer to let the customer know that the application acceptance has been completed (S1020) and also transmits the application information to the terminal of the collector (PDA, mobile phone, iPhone, wipon etc.).

Next, the system for processing the door-to-door parcel acceptance determines collecting sequence that is the gathering of goods order by mapping the application information collected for the collectors with the local door-to-door parcel GIS sequence database (S1040).

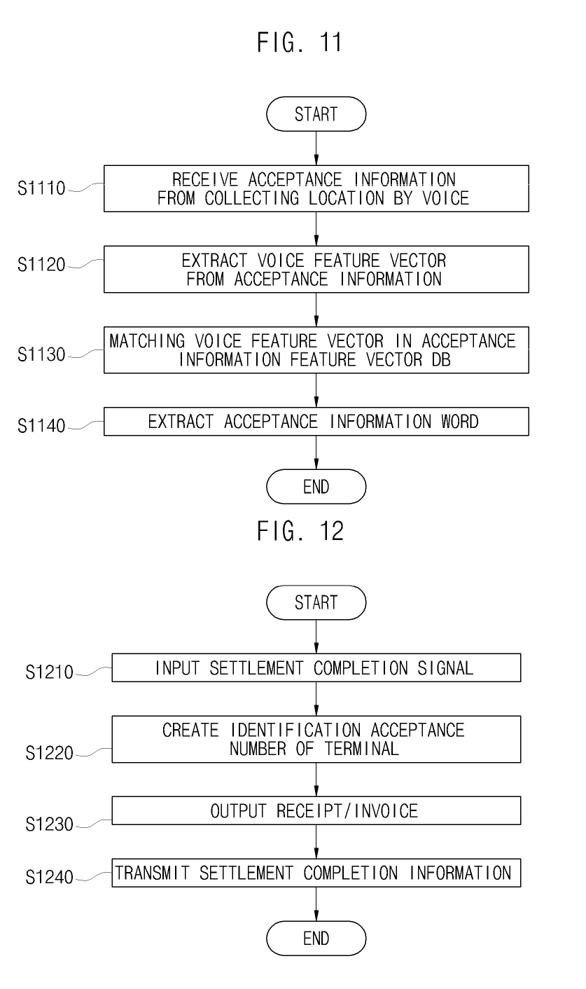

A step of acquiring acceptance information for postal matter acceptance according to another exemplary embodiment of the present invention is described with reference to FIG. 11. FIG. 11 is a flowchart showing a process of acquiring collecting location acceptance information on the basis of voice-recognized door-to-door parcel information in a method for processing door-to-door parcel acceptance information based on voice recognition according to another exemplary embodiment of the present invention.

First, the system for processing the door-to-door parcel acceptance receives acceptance information by voice from the collecting location (S1110). The acceptance information may include sender information, receiver information, parcel information, and settlement information etc.

Further, the system for processing the door-to-door parcel acceptance extract a voice feature vector from the acceptance information input by voice (S1120), matches the patterns between the extracted voice feature vector and the local/national acceptance information feature vector database (S1130), and extracts acceptance information words (S1140).

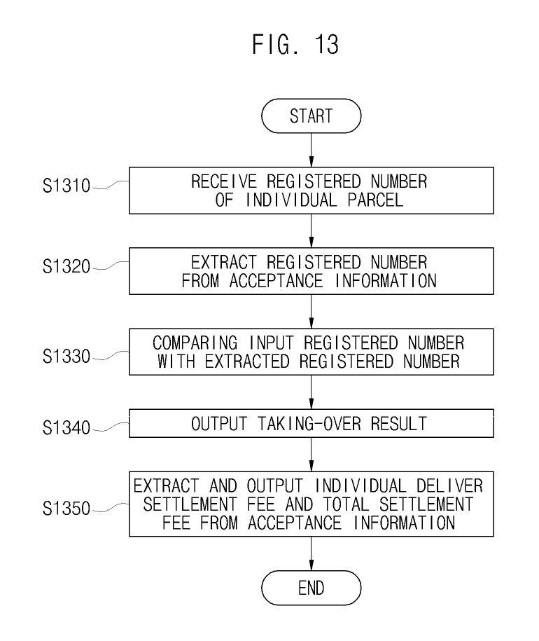

A step of printing a receipt and an invoice and registering acceptance information for acceptance of a postal matter, according to another exemplary embodiment of the present invention, is described with reference to FIG. 12. FIG. 12 is a flowchart showing a process of issuing a receipt and an invoice and registering information on the basis of parcel acceptance information in a method for processing door-to-door parcel acceptance information based on voice recognition according to another exemplary embodiment of the present invention.

First, the system for processing the door-to-door parcel acceptance receives a settlement completion signal from a user (S1210) and creates an identification acceptance number for the collector's terminal (S1220).

Next, the system for processing the door-to-door parcel acceptance outputs a receipt and an invoice which are printed with the terminal identification acceptance number (S1230) and transmits the settlement completion information in real time to a server in the post office, using a mobile communication network or a wireless communication network (S1240).

If when one customer requests several items, an invoice to attach to an individual parcel is needed for one acceptance number and a barcode including a registered number should be printed on the invoice, such that the receipt should be provided with necessary information, such as the acceptance number, the total deliver amount of money, registered number of individual parcels, and the sender and the invoices should be printed with the sender's name, address, zip code, the registered numbers, the receiver's zip code, address, name, telephone number, the contents in the parcels, service types, and acceptance date etc. to be attached to the parcels, in which the invoices may be easily attached to the parcels by using labels.

Further, the settlement completion information can be automatically transmitted to the server in the post office through a wireless communication network from a terminal in the system for processing the door-to-door parcel acceptance, or may be automatically transmitted through cradle, which is a docking device of an acceptance terminal, such as a PC or a PDA, used by the collector returning to the post office.

A process of outputting the final finishing information on the basis of the acceptance information, according to another exemplary embodiment of the present invention, is described with reference to FIG. 13. FIG. 13 is a flowchart showing a process outputting final finish information on the basis of acceptance information in a method for processing door-to-door parcel acceptance information based on voice recognition according to another exemplary embodiment of the present invention.

First, the system for processing the door-to-door parcel acceptance receives a registered number ID recognized by a barcode scanner at the inlet of a conveyer in the post office while an individual parcel is moved to the arrival-departure department (S1310).

Next, the system for processing the door-to-door parcel acceptance extracts individual information including the registered number of the collected individual parcel from the final acceptance information (S1320), automatically compares the registered number with the registered number of the parcel which has been recognized by a barcode scanner to ascertain whether they are the same (S1330), and provides the taking-over result (S1340).

The collector and the arrival-departure official can automatically immediately check an error that may be generated in taking-over by confirming the taking-over result displayed on a screen.

Further, the system for processing the door-to-door parcel acceptance extracts and outputs the individual information including the settlement fees of the collected individual parcels, the total settlement fee of collected individual parcels, and the registered numbers of the individual parcels (S1350).

According to the exemplary embodiments of the present invention, it can increase efficiency of performing a work by inputting postal matter acceptance application information and door-to-door parcel acceptance information to a postal matter acceptance device, such as a computer, a PDA, or a mobile phone, by voice to implement the acceptance information with characters, and providing information in real time to a customer and a post office, when a postal matter is received.

Further, according to the exemplary embodiments of the present invention, it can improve service quality provided to a customer in addition to reducing the cost, because a receptionist can easily performs a finishing work after returning to the post office, such that the process of the whole acceptance process works becomes convenient and simple.

In addition, according to the exemplary embodiments of the present invention, a receptionist can conveniently and safely perform a work associated with the result, handling parcels, and giving fees after returning to the post office, without manual invoices, such that it is possible to reduce discomfort in working.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A post office server for a system for processing door-to-door parcel acceptance information based on voice recognition including a post office server and a collector that process acceptance application information and acceptance information for a postal matter, the server comprising:
a voice input block that receives acceptance application and collecting location information for the postal matter by voice and creates corresponding voice data;
a door-to-door parcel information process block that acquires the acceptance application information and the acceptance information implemented by characters, by performing voice recognition to the voice data and provides information for each process of a door-to-door parcel acceptance work in real time by processing the acceptance application information and the acceptance information; and
an acceptance management block that displays and stores the information output from the door-to-door parcel information process block.

2. The server of claim 1, wherein the door-to-door parcel information process block includes:
a door-to-door parcel application information acquiring unit that acquires acceptance application information implemented by characters, by performing voice recognition for the voice data;
a collector assigning/confirming unit that assigns a collector in charged of the door-to-door parcel application area in accordance with the acceptance application information;
a collecting location acceptance information acquiring unit that acquires acceptance information implemented by characters by performing voice recognition for the voice data;
a door-to-door parcel acceptance registration/receipt/invoice issue unit that transmits a signal for outputting a receipt and an invoice to the terminal of the collector in accordance with the acceptance information; and
a door-to-door parcel finishing information process unit that collects the acceptance information and outputs finishing information including a result of comparing settlement fee and registered number of an individual parcel from each collector.

3. The server of claim 2, wherein the door-to-door parcel application information acquiring unit selects a local/national voice feature vector database used for pattern-matching in accordance with a telephone application area receiving the voice data, and performs voice recognition for the district receiving the telephone application, using the selected voice feature vector database.

4. The server of claim 2, wherein the door-to-door parcel application information acquiring unit extracts an address voice feature vector from the voice data, separate the address voice feature vector in accordance with an address vocalization way, and acquires address information including a Dong-name feature vector or a Gu(Myeon)+Dong(Ri)-name feature vector, using the separated address voice feature vector.

5. The server of claim 2, wherein the door-to-door parcel application information acquiring unit extracts a telephone number voice feature vector from the voice data, matches patterns between the extracted telephone number voice feature vector and a telephone number feature vector database, extracts telephone number words (numbers), searches the extracted telephone number words from a customer information database storing personal information of customers, and then extracts the personal information corresponding to the searched telephone number, thereby acquiring acceptance information implemented by characters.

6. The server of claim 2, wherein collector assigning/confirming unit extracts a zip code from the address information in the acceptance application information, assigns in-charge post office and collector from a database of the in-charge post office/collecting office on the basis of the extracted zip code, and transmits the acceptance application information to the terminal of the collector.

7. The server of claim 2, wherein the collector assigning/confirming unit searches a local door-to-door parcel geographic information database on the basis of the address information in the acceptance application information, arranges the acceptance application information in accordance with gathering of goods sequence information (geographic information of the applied address) matched with the search result, and transmits the arranged acceptance application information to the terminal of the collector.

8. The server of claim 2, wherein the collecting location acceptance information acquiring unit extracts voice feature vector for sender information, parcel information, and settlement information from the voice data and acquires acceptance information implemented by characters, by matching patterns between the extracted voice feature vector and an acceptance information feature vector database.

9. The server of claim 2, wherein the door-to-door parcel acceptance registration/receipt/invoice issue unit creates an acceptance number and a registered number for a corresponding item in accordance with the acceptance information and transmits a signal for outputting a receipt and an invoice which are printed with the acceptance number and the registered number to the terminal of the collector.

10. The server of claim 2, wherein the door-to-door parcel acceptance registration/receipt/invoice issue unit includes an acceptance information storage management database that stores final acceptance information composed of the character information transmitted from the terminal of the collector which prints the receipt and the invoice.

11. The server of claim 10, wherein door-to-door parcel finishing information process unit includes:
a postal matter taking over unit that extracts individual information including a registered number of a collected individual parcel from the final acceptance information stored in the acceptance information storage and management database, automatically compares the registered number with a registered number of the individual parcel which is recognized by a barcode scanner to ascertain whether the registered numbers are the same, and provides a taking-over result; and
a fee acceptance door-to-door parcel finishing unit that extracts and outputs individual information including the settled fees of the collected individual parcels, the total settlement fee of the collected parcels, and the registered numbers of the individual parcels from the final acceptance information stored in the acceptance information storage management database.

12. A method of operating by a post office server in a system for processing door-to-door parcel acceptance information based on voice recognition including a post office server and a terminal of a collector which process acceptance application information and acceptance information for a postal matter, the method comprising:
receiving acceptance application of a postal matter by voice and acquiring acceptance application information including at least one of a name, an address, and a telephone number by performing voice recognition;
assigning a post office and a collector in charge of a corresponding area in accordance with the acceptance application information;
receiving collecting location information from a collecting location by voice and acquiring acceptance information including at least one of receiver information, sender information, parcel information, and settlement information by performing voice recognition;
transmitting a signal for outputting a receipt and an invoice for the corresponding item to the terminal, in accordance with the settlement information; storing final acceptance information composed of characteristic information transmitted from the terminal; and
outputting finishing information including a settlement fee and a registered number of an individual parcel from each collector, from the final acceptance information.

13. The method of claim 12, wherein the acquiring of acceptance application information includes:
receiving application information voice data for acceptance application of the postal matter;
extracting a voice feature vector from the voice data;
matching patterns between the extracted voice feature vector and a local/national voice feature vector database;
extracting application information words corresponding to the extracted voice feature vector in accordance with the matching result;
searching the application information words from a local door-to-door parcel customer information database storing personal information of customers; and
acquiring acceptance application information implemented by characters, by extracting the personal information of the customer corresponding to the application information words.

14. The method of claim 13, wherein the matching of patterns with a local/national voice feature vector database includes selecting the local/national voice feature vector database that is used for pattern-matching in accordance with the telephone application area receiving the voice data.

15. The method of claim 12, wherein the assigning of a post office and a collector include:
assigning a post office and a collector in charged of the address on the basis of the address information in the acceptance application information;
transmitting information on the in-charge collector and a collectin date to a customer;
transmitting the acceptance application information to the terminal of the collector; and
searching a local door-to-door parcel geographic information database on the basis of the address information, arranging the acceptance application information in accordance with gathering of goods sequence information (geographic information of the applied address) matched with the search result, and transmitting the arranged acceptance application information to the terminal of the collector.

16. The method of claim 12, wherein the acquiring of acceptance information include:
receiving voice data for the acceptance data of the postal matter;
extracting a voice feature vector from the voice data;
matching patterns between the extracted voice feature vector and a local/national acceptance information feature vector database; and
extracting acceptance information words corresponding to the extracted voice feature vector in accordance with the matching result.

17. The method of claim 12, wherein the transmitting of an output signal to the terminal includes:
receiving a settlement completion signal from the terminal of the collector and creating an identification acceptance number of the terminal of the collector; and
transmitting a signal for outputting a receipt and an invoice which are printed with the acceptance number to the terminal.

18. The method of claim 12, wherein the outputting of finishing information includes:
extracting individual information including the registered number of the collected individual parcel from the final acceptance information, automatically comparing the registered number with the registered number of the parcel which has been recognized by a barcode scanner to ascertain whether they are the same, and providing the taking-over result; and
extracting and outputting individual information including the settled fees of the collected individual parcels, the total settlement fee of the collected parcels, and the registered numbers of the individual parcels from the final acceptance information stored in the acceptance information storage management database.
